(19) United States
(12) Patent Application Publication
(10) Pub. No.: US 2018/0369741 A1
(43) Pub. Date: Dec. 27, 2018

(54) PORTABLE OXYGEN CONCENTRATOR SIEVE BED

(71) Applicant: KONINKLIJKE PHILIPS N.V., Eindhoven (NL)

(72) Inventors: DOUGLAS ADAM WHITCHER, MARIETTA, GA (US); BRIAN EDWARD DICKERSON, CANTON, GA (US); RICKEY DEAN BURNS, ALPHARETTA, GA (US); ROBERT JACKSON MADDOX, CARTERVILLE, GA (US); ACHIM GERHARD ROLF KOERBER, EINDHOVEN (NL); RAINER HILBIG, AACHEN (DE)

(21) Appl. No.: 16/018,703

(22) Filed: Jun. 26, 2018

Related U.S. Application Data
(60) Provisional application No. 62/525,315, filed on Jun. 27, 2017.

(51) Int. Cl. B01D 53/04

(52) U.S. Cl. CPC B01D 53/0446; B01D 2253/108; B01D 2259/402; B01D 2257/102; B01D 2256/12

(57) ABSTRACT

The present disclosure pertains to sieve bed. The sieve bed comprises a housing configured to define a path for a flow of oxygen comprising gas. The housing comprises a gas inlet configured to guide the flow of oxygen comprising gas into the housing; a gas outlet configured to guide a flow of oxygen enriched gas out of the housing; and a sieve bed configured to receive the flow of oxygen comprising gas from the gas inlet, wherein the flow of oxygen comprising gas flows through the sieve bed and oxygen enriched gas flows out of the sieve bed via the gas outlet, and wherein the path of the flow of oxygen comprising gas through the sieve bed is longer than a longest dimension of the housing.

### CROSS-REFERENCE TO RELATED APPLICATIONS

This patent application claims the priority benefit under 35 U.S.C. § 119(e) of U.S. Provisional Application No. 62/525,315 filed on Jun. 27, 2017, the contents of which are herein incorporated by reference.

### BACKGROUND

### 1. Field

The present disclosure pertains to a system and method for concentrating oxygen.

### 2. Description of the Related Art

Degradation of the adsorption capacity of adsorbents used in gas separation devices such as oxygen concentrators is a known phenomenon and is described in literature such as U.S. Pat. Nos. 7,037,358; 7,160,367, and 9,486,730. The typical adsorbents used in oxygen concentrators such as lithium exchanged zeolite (LiLSX molecular sieve) are susceptible to contaminants like atmospheric humidity that can cause degradation of the adsorbents ability to preferentially adsorb Nitrogen. There have been attempts to address the degradation rate of smaller and smaller sieve beds by adding guard layers of materials such as activated alumina and by simply making the sieve beds easily replaceable in the field as seen in U.S. Pat. Nos. 8,894,751 and 9,592,360. It became also accepted with existing systems that the life of the sieve beds in small portable oxygen concentrators will be significantly shorter than the desired useful life of the device. This can be seen in the shift in warranties offered in the market where for example a three year warranty is offered on the device but only a one year warranty is offered on the sieve beds.

### SUMMARY

Accordingly, one or more aspects of the present disclosure relate to a sieve bed. The sieve bed comprises a housing (Sieve Tube) that contains the sieve bed components including the sieve material. A gas inlet is configured to guide the flow of oxygen comprising gas into the sieve bed. A gas outlet is configured to guide a flow of oxygen enriched gas out of the sieve bed. A sieve material receives the flow of oxygen comprising gas from the gas inlet. The flow of oxygen comprising gas flows through the sieve bed and oxygen enriched gas flows out of the sieve bed via the gas outlet. The path of the flow of oxygen comprising gas through the sieve bed is longer than a longest dimension of the sieve bed.

Another aspect of the present disclosure relates to a method for concentrating oxygen. The method comprises (a) defining, through the sieve bed, a path for a flow of oxygen comprising gas; (b) guiding, with a gas inlet, the flow of oxygen comprising gas into the sieve bed; and (c) receiving, with a sieve material, the flow of oxygen comprising gas from the gas inlet. The flow of oxygen comprising gas flows through the sieve material and oxygen enriched gas flows out of the sieve material via a gas outlet. The path of the flow of oxygen comprising gas through the sieve material is longer than a longest dimension of the sieve bed; and guiding with the gas outlet the flow of oxygen enriched gas out of the sieve bed.

Still another aspect of present disclosure relates to an adsorption device. The adsorption device comprises means for defining a path for a flow of oxygen comprising gas. The means for defining the path comprises: means for guiding the flow of oxygen comprising gas into the means for defining the path; means for guiding a flow of oxygen enriched gas out of the means for defining the path; and means for receiving the flow of oxygen comprising gas from the means for guiding the flow of oxygen comprising gas. The flow of oxygen comprising gas flows through the means for receiving the flow of oxygen comprising gas and oxygen enriched gas flows out of the means for receiving the flow of oxygen comprising gas via means for guiding a flow of oxygen enriched gas out of the means for defining the path. The path of the flow of oxygen comprising gas is longer than a longest dimension of the means for defining the path.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1-A is a schematic illustration of a system for concentrating oxygen in accordance with one or more implementations;

FIG. 1-B is a schematic illustration of a sieve bed in accordance with one or more implementations;

FIG. 2 is a schematic illustration of a of a typical sieve bed moisture adsorption;

FIG. 3 illustrates an example of a typical sieve bed degradation graph;

FIG. 4 illustrates an example of square root of time graph of the typical sieve bed of FIG. 3;

FIG. 5 illustrates another example embodiment of a sieve bed housing in accordance with one or more implementations;

FIG. 6 illustrates yet another example embodiment of a sieve bed housing in accordance with one or more implementations;

FIG. 7 illustrates a still further example embodiment of a sieve bed housing in accordance with one or more implementations; and

FIG. 8 illustrates an example diagram of operations performed by the system in accordance with one or more implementations.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Generally, oxygen may be purified from air in an oxygen concentrator by a process called Pressure Swing Adsorption (PSA). An oxygen concentrator is generally built with two tubes filled with a molecular sieve material (e.g., Zeolite). This material is designed to preferentially adsorb nitrogen over oxygen or argon. This attribute can be used to produce oxygen and/or argon enriched product gas stream when pressurized air flows through one of the molecular sieve beds by removing a majority of the nitrogen molecules from the stream. Ambient air is made up of about 78.09% Nitrogen, about 20.95% Oxygen, 0.93% Argon, about 0.039% Carbon Dioxide, and trace amounts of other gases including water vapor. If most of the nitrogen is removed from the air then the resulting product gas would be approximately about 95.58% oxygen and about 4.24% argon. Generally, a single tube of molecular sieve (sieve bed) has a finite nitrogen adsorption capacity at any fixed pressure and temperature before nitrogen adsorption equilibrium is reached and nitrogen starts breaking through the oxygen outlet of the Sieve Bed. Shortly before this point is reached, oxygen production switches to the second bed while the first bed exhausts its pressure and regenerates to equilibrium at ambient conditions. This process continues back and forth between the two beds to supply a nearly continuous flow of enriched oxygen gas to a patient.

Degradation of adsorbents is generally driven by water molecules entering the system during operation of the pressure swing adsorption process or during off times due to leakage from outside ambient air. These water molecules may ultimately bond to adsorption sites on the zeolite that would normally be used to adsorb Nitrogen. Water molecules are also able to diffuse down the length of the sieve bed during off or idle times of the system and it is this off time diffusion that is becoming more and more important in the portable oxygen concentrator market. As technologies for valves, sieve material, compressors PSA cycles, and manufacturing capabilities continue to advance and the need for smaller and lighter portable concentrators continues to grow there is a desire to continue to miniaturize the entire oxygen concentrator device. This usually leads to smaller and smaller adsorbent beds (sieve beds) with lower bed size factors (ratio of quantity of adsorbent used to oxygen output) which become more and more susceptible to degradation. These portable devices are also used more intermittently than larger concentrators, or larger gas separation devices, which leads to a higher proportion of idle time to operational time. Generally, during idle time water molecules within the sieve bed can diffuse down the length of the adsorbent at a rate that is inversely proportional to the square of the length.

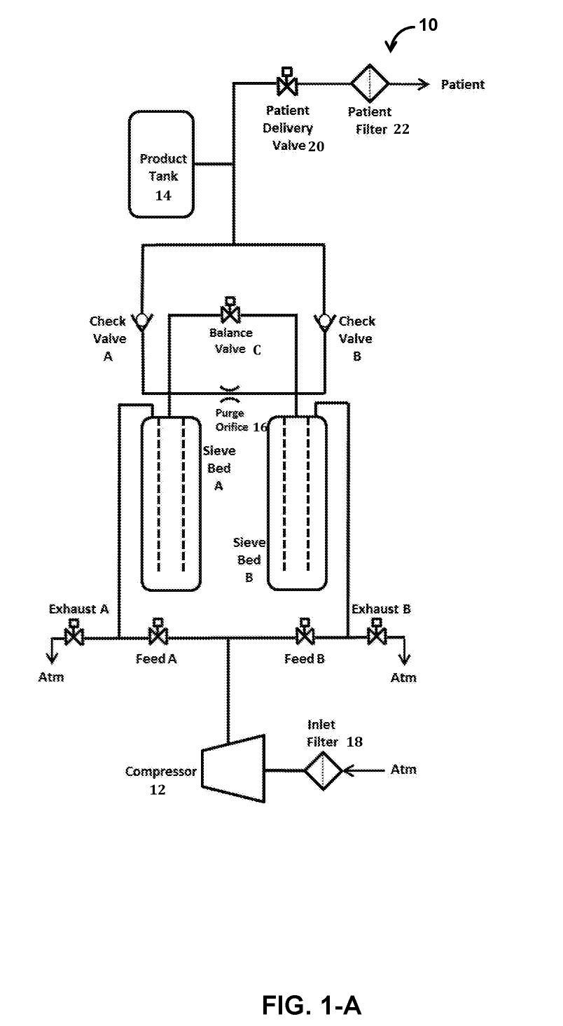

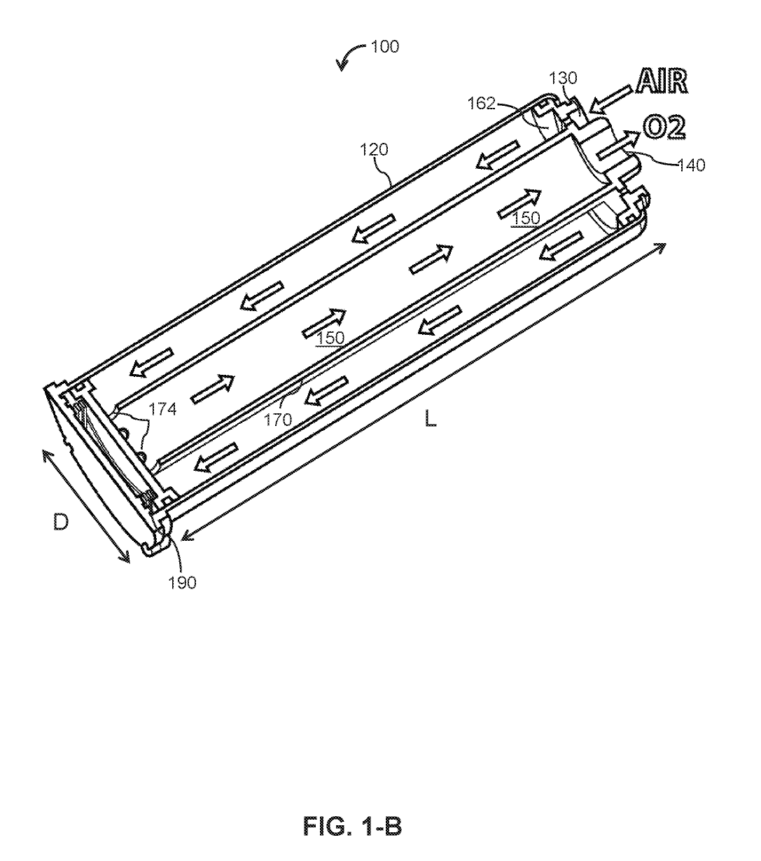

FIG. 1-A is a diagram of an oxygen concentrator 10 in accordance with one or more embodiments. Oxygen concentrator 10 may overcome some or all the shortcomings of existing systems. Generally, PSA cycle involves five steps. These steps include pressurization, oxygen production, balance, blowdown (exhaust), and purge. Below is a description of these steps starting with sieve bed A being pressurized.

Pressurization: Compressor 12 feeds air to sieve bed A through open feed valve A increasing its pressure resulting in the nitrogen being adsorbed out of the gas flow leaving a purified oxygen flow front progressing ahead of the nitrogen adsorption zone. When the increased pressure in sieve bed A surpasses the pressure of the oxygen gas stored in the product tank 14 check valve A opens. Note exhaust valve A (used to vent air pressure from the appropriate sieve bed A) is closed, feed valve B is closed, check valve B is closed due to sieve bed B low pressure, and exhaust valve B (used to vent air pressure from the appropriate sieve bed B) is open.

Oxygen Production: Compressor 12 continues feeding air to sieve bed A that results in the progression of the nitrogen adsorption zone towards the oxygen end of the bed flow path while pushing the purified oxygen gas through the open check valve into product tank 14. In some embodiments, product tank 14 is a gas storage tank used as a pressure buffer to help provide a relatively steady source of enriched oxygen gas to deliver to the patient. The oxygen production step should end before the nitrogen adsorption zone reaches the oxygen outlet of the bed preventing nitrogen gas from breaking through and flowing into the product tank 14 lowering the purity of the stored oxygen to be supplied to the patient.

Balance: At the end of the oxygen production step sieve bed A is pressurized to near its maximum cycle pressure, and sieve bed B is near atmospheric pressure. The free gas molecules in the interstitial space between the sieve beads are near the mixture of atmospheric air or partially oxygen purified. The Nitrogen molecules removed during the last two steps are still primarily adsorbed within the sieve material. Just dumping this pressurized gas to atmosphere would waste significant energy to pressurize more ambient air then necessary in the next step. Therefore, to recover some of this energy exhaust valve B is closed and balance valve C is open at the oxygen outlets of the sieve beds for a short time to equalize the pressure between the two beds. This way, less energy is required to pressurize new air in sieve bed B. Midway through the balance step the air feed is switched from feed valve A to feed valve B.

Blowdown: To dump the remaining pressurized gas from sieve bed A to atmosphere allowing its sieve to desorb the excess nitrogen in sieve bed A exhaust valve A is opened.

Purge: Whenever the pressure in one bed is lower than the pressure in the other bed a small flow of oxygen enriched gas flows from the oxygen outlet of the higher pressure bed through the purge orifice 16 into the oxygen outlet of the lower pressure bed being vented to purge out excess nitrogen gas from that bed to atmosphere. In this case sieve bed A is purged using enriched oxygen flow from sieve bed B. The purge step is used to clean up sieve bed A of excess nitrogen that would just re-adsorb reducing the air separation capacity of the following cycle.

The two sieve beds work in tandem with one bed being in the pressurization/oxygen production side of the cycle while the other bed is in the blowdown/purge side of the cycle. During the next half cycle the two beds switch steps to produce a nearly steady flow of enriched oxygen gas. In some embodiments an inlet filter 18 may be used to filter out larger particles in the air before entering the device. In some embodiments, a check valve A may be used to allow enriched oxygen gas being generated to flow into the product tank 14 whenever pressure of sieve bed A exceeds the product tank pressure. In some embodiments, a check valve B may be used to allow enriched oxygen gas being generated to flow into the product tank 14 whenever pressure of sieve bed B exceeds the product tank pressure. In some embodiments a patient delivery valve 20 may be used. For example, in a constant flow concentrator as usually found on a larger stationary unit patient delivery valve 20 may be a needle valve that controls a steady flow through a patient set rotameter (Flow shown by a floating ball in a clear tube). In a Portable Oxygen Concentrator (POC) patient delivery valve 20 may be a direct acting solenoid valve controlled by a patient breath detection circuit to deliver a specified pulsed bolus volume at the initiation of each breath depending on the flow setting of the unit in some embodiments. A patient filter 22 (e.g., a fine filter media) may be used in some embodiments to provide a clean flow of nearly particulate free oxygen to the patient.

As mentioned above, water vapor molecules adsorbs to the molecular sieve material with even higher bond strengths then nitrogen molecules. The bond strength of water molecules can be strong enough that some of the water vapor molecules will irreversibly adsorb to the sieve material until steady state adsorption is reached (water molecules flowing in during Feed equals water molecules purged out during blowdown and purge) contaminating the sieve material at the inlet end of the sieve bed flow path. Due to the highly polar value of water molecules they will adhere not only to potential nitrogen adsorption sights, but also to other surfaces near the inlet end that are not available for nitrogen adsorption as the initial steady state adsorption develops. While the PSA cycle is running the gas flow in and out of the sieve beds greatly retards water diffusion further down the bed. When the gas flow stops while the unit is off (intermittent use) there is nothing to prevent natural diffusion of water molecules from the weaker adsorbed surfaces downstream to the stronger adsorption sites available for nitrogen adsorption contaminating a greater length of the bed. The next time the PSA cycle is started the sieve beds no longer start out in cyclic steady state since some of the water molecules from the inlet end of the beds were lost to diffusion downstream. Therefore initially after each restart following enough time for water diffusion to occur the net flow of moisture molecules is again into the sieve bed until a new steady state is formed with a longer water contaminated zone.

FIG. 1-B is a schematic illustration of a sieve bed 100 for use in an oxygen concentrator (e.g., oxygen concentrator of FIG. 1-A) in accordance with one or more embodiments. Sieve bed 100 is expected to overcome some of the shortcomings of typical sieve beds. In some embodiments, sieve bed 100 (e.g., sieve bed A or sieve bed B of FIG. 1) includes a housing 120 configured to define a path (shown by arrows 150) for a flow of oxygen comprising gas. In some embodiments, sieve bed 100 includes a gas inlet 130 configured to guide the flow of oxygen comprising gas into sieve bed 100, and a gas outlet 140 configured to guide a flow of oxygen enriched gas out of sieve bed 100 after passing through the sieve material within the sieve bed 100. In some embodiments, there is a closed end counter flow passageway within the sieve bed 100 (containing the sieve material) returning the oxygen enriched outlet flow to the same end that the inlet gas initially flowed in. In some embodiments, gas inlet 130 and gas outlet 140 may be located on different ends of the sieve bed 100 (e.g., on opposite ends). In some embodiments, the sieve material is compressed by a loaded spring 190 located at or towards the closed end of the housing 120. The components of the sieve bed 100 are retained by a crimp formed at the open end of the housing 120 over the upper edge of the top cap 162. In the example of FIG. 1-B, spring 190 is positioned outside of the pressurized portion of the sieve bed 100 to minimize dead space (space inside sieve bed 100 with no adsorbent material).

In some embodiments, the flow of oxygen comprising gas flows through the annular space between the housing 120 and the inner tube 170 from inlet 130 then flows through the openings 174 in the lower end of the inner tube and back up through the inner tube through outlet 140 such that the path 150 of the flow of oxygen comprising gas through the sieve material is longer than the longest dimension of sieve bed 100 (sieve bed 100 generally has a length L and a Diameter D). As shown in FIG. 1-B, flow path 150 is approximately twice as long as length L (the longest dimension of sieve bed 100).

In some embodiments, in operation, the flow of oxygen comprising gas (e.g., received from a compressor 12 described in FIG. 1-A via gas inlet 130) is guided through sieve bed 100 in a multi-pass path (as shown by arrows 150.) The effective length of the sieve bed created by these embodiments is approximately twice as long as the length of sieve bed 100. This is expected to at least double the effective flow length of the sieve bed while maintaining the same overall size of the sieve bed 100. In some embodiments, doubling of the effective length of the sieve bed is expected to lengthen the useful life of the sieve beds. Degradation rate (of the sieve bed) is inversely proportional to the square of the length. Therefore, a doubling of the effective length can lengthen the useful life of the sieve beds by a factor of up to four in some embodiments.

The oxygen comprising gas, as used herein, may refer to any gas which at least partly comprises gaseous oxygen, or which consists of oxygen. The term oxygen enriched gas shall thereby mean a gas which has a higher concentration with respect to oxygen compared to the oxygen comprising gas and which may be in some cases pure oxygen.

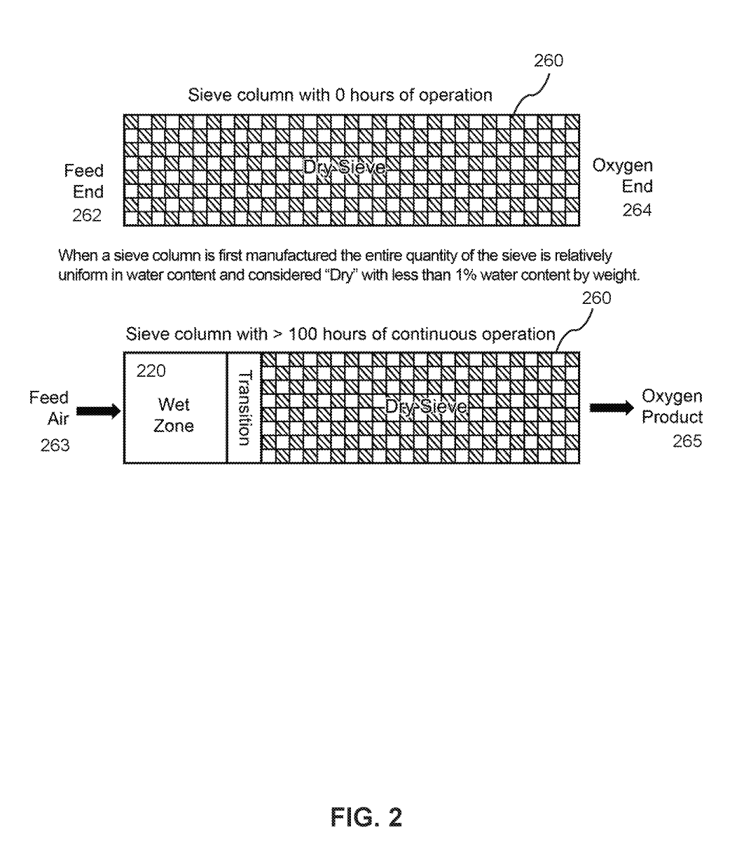

FIG. 2 illustrates an example of a dry sieve bed 260 and sieve bed 260 with over 100 hours of continuous operation. Generally, when a sieve bed is first manufactured the entire quantity of the sieve material is relatively uniform in water content and considered “Dry” with less than about 1% water content by weight. In some embodiments, once sieve bed 260 begins to be used in a pressure swing adsorption (PSA) process, inlet 262 (also referred to as the feed end 262) may become contaminated by moisture from feed air 263 used to operate the process. In some cases, the incoming water may bind to the same adsorption sites on molecular sieve bed 260 that are used in the PSA process to selectively adsorb nitrogen. Pressure Swing Adsorption relies on swings in pressure to cycle the sieve bed sequentially from selective adsorption to desorption. This swing can occur from above atmospheric pressure to atmospheric pressure or from atmospheric pressure to vacuum. If the swing occurs from a vacuum to a positive pressure, it is considered Vacuum Pressure Swing Adsorption (VPSA), and if the swing occurs from vacuum to atmospheric pressure it is considered Vacuum Swing Adsorption Cycle (VSA).

The contaminated region is shown in FIG. 2 as water zone 220. In some embodiments, in operation, as sieve bed 260 is used continuously, water zone 220 grows in size until it reaches a near cyclical steady state. At this point, the amount of water entering sieve bed 260 each feed cycle is nearly equal to the amount of water purged back out of sieve bed 260 during the exhaust and purge portions of the PSA process. This results in the size/length of the water zone no longer growing at a meaningful rate and the sieve bed may operate (in some cases almost indefinitely) without further degradation. The relative size of the initial near cyclical steady state water zone compared to the overall dimensions of the housing that contains the sieve bed is a function of the input air flow rate and humidity level, timing parameters of the PSA process and velocities of the feed and purge flows, as well as the geometry of the sieve bed or the housing that contains the sieve bed. In some embodiments, formation of water zone 220 on feed end 262 may proportionately reduce the total adsorption capacity of sieve bed 260. Generally, a new sieve bed loses about 15% of its capacity during the first 100 hours of operation after which the continued degradation during continuous operation would be minimal.

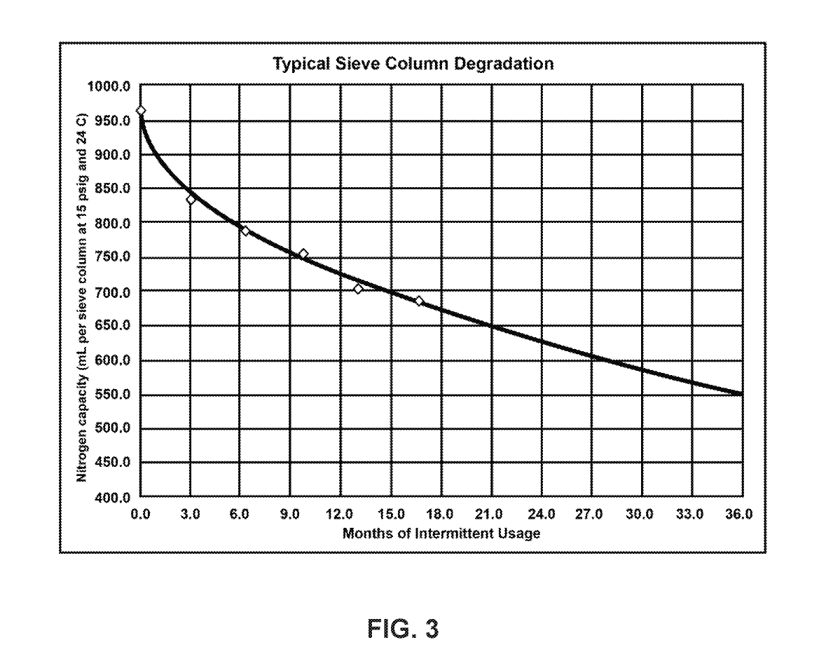

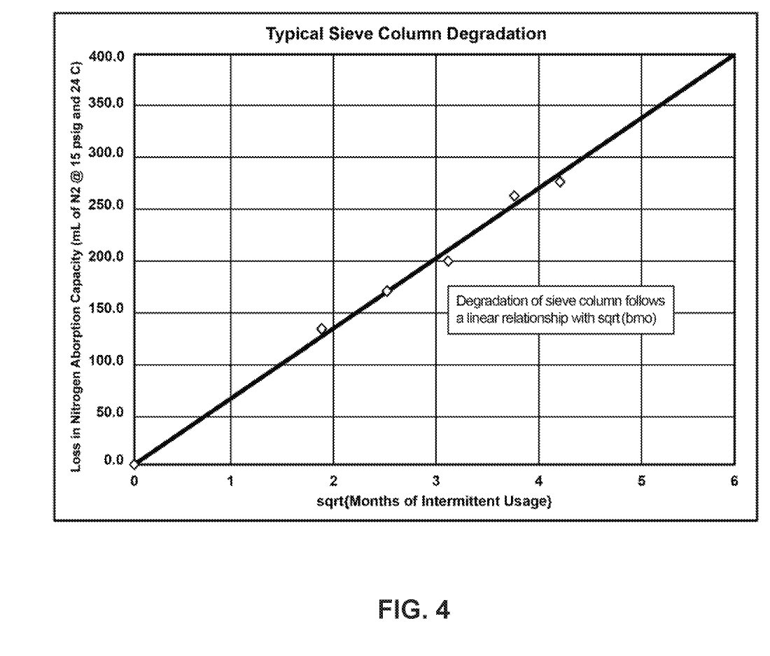

However, if an oxygen concentrator is not used continuously (e.g., used intermittently), this type of usage profile may lead to extended periods of off time in which the water zone is able to start diffusing down the length of the sieve bed at a rate that is meaningful compared to the desired useful life of the concentrator device. The diffusion rate of water zone 220 has a square root dependence on time. In particular this dependence is inversely proportional, in other words: as time increases the diffusion rate decreases with the following relationship [diffusion rate ∝1/(√time)]. FIGS. 3-4 illustrate examples of adsorption capacity decreasing over time for a sieve bed used intermittently in a portable oxygen concentrator. FIG. 3 illustrates an example of a typical sieve bed degradation graph. FIG. 4 illustrates an example of square root of time graph of a typical sieve bed degradation. FIG. 4 shows that if the test data from FIG. 3 were plotted per the square root of time the curve would become a straight line illustrating that the time dependent of sieve bed degradation is a linear relationship with the square root of time. As can be seen, given that the diffusion rate decreases inversely with the square root of time, this results in the total capacity lost having a linear relationship with the square root of time.

In operation, the water zone 220 is diffusing down the length of the sieve bed each time a device that includes a sieve bed is off and it is this diffusion of water that may further decrease the adsorption capacity of the sieve by the water molecules binding to sites on the sieve that would typically be used for nitrogen adsorption in the PSA process and hence further decreasing the total nitrogen adsorption capacity of the sieve bed. In some cases, there may be multiple types of bonding sites within the sieve bed with some types/locations being much stronger and others being much weaker in bond energy. The strong bonding sites are generally those used to selectively adsorb nitrogen in the PSA process, and the weaker bonding sites generally tend to release their water molecules over time to diffuse down the length of the sieve bed. Ultimately, the diffusing water molecules will find their way to strong bonding sites and become for all practical purposes permanently bonded at a site that reduces the nitrogen adsorption capacity of the sieve bed. And each sequential time the device is ran the weak bonding sites within the initial water zone once again becomes fully contaminated with water which allows for more potential water to diffuse once the device is again turned off.

Given this description of how the water zone forms in a sieve bed while running continuously and then how it can diffuse down the length of the bed during off periods, some embodiments of the present invention consider ways to improve the overall useful life of the sieve bed. For example, consider the overall length of the water zone and how it increases during off periods:

Length of Water Zone=Initial Length+(avg. diffusion rate) (time)

Here, the total length of the water zone is equal to the initial steady state length plus the average diffusion rate times time. Or more specifically, the increase in the length of the water zone is equal to the integral of the diffusion rate over time and we know that the diffusion rate itself is inversely proportional to the square root of time.

diffusion rate=constant/√time

So substituting this relationship in and solving for the relationship between time and increase in length of the water zone we get the following:

Length of Water Zone=Initial Length+(constant/√time) dt

Length of Water Zone−Initial Length=ΔLength

Δlength=∫(constant/√time) dt=2*constant √time

time=(ΔLength/(2*constant))Λ2

Time ∝ΔLengthΛ2

Here, the time required to degrade a certain length of the sieve bed is proportional to the square of the length degraded. For example, applying the findings above, doubling of the length of the sieve bed can increase the useful life of the sieve bed by up to a factor of four, assuming other parameters related to the formation of the initial length of the water zone are held constant. Or for example if the length is tripled the useful life of the sieve bed may be increased by up to a factor of nine (assuming other parameters related to the formation of the initial length of the water zone are held constant). These parameters include input air flow rate, humidity level, timing parameters of the PSA process, velocities of the feed, purge flows, as well as the geometry of the sieve bed.

Currently typical sieve beds are usually tubes packed with a length of sieve material, and the aspect ratio of a sieve bed would be the length of the sieve material inside the tube divided by the inside diameter. For example if a tube was 4.2 inches long with a 1.5 inch ID the aspect ratio would be 2.8. If you wanted to build a sieve bed with a much longer sieve filled flow path in a single straight tube it would greatly limit your ability to shrink down the size of a portable oxygen concentrator to dimensions that would be desirable. One solution would be a closed end counter flow tube in tube sieve bed as described in this patent. For example a sieve bed filled with the same length of sieve material and diameter constructed with the tube in tube design would have a flow length of about 8.4 inches and a flow cross sectional area equivalent to a 0.83 inch diameter resulting in an aspect ratio of 10.1 with about the same volume of sieve material and a final sieve bed assembly about the same overall size as the one above. Therefor the tube in tube design of this invention would allow sieve beds with much longer flow path and larger aspect ratios that would degrade much slower due to water diffusion to still fit into a small enclosure.

It is believed by many that large aspects ratios should be avoided due to a high pressure drop across the length of the sieve bed resulting in greater power draw to run the unit. This may be so with larger systems operating with larger pressure swings, and portable units designed with a very low bed size factor BSF that runs at very fast cycle times. Our testing shows that by designing the bed using just a little more sieve material, a PSA cycle having little longer cycle times, and operating across little less pressure swing there is little difference in power draw that is quickly overcome by the slower degradation of the sieve. As sieve beds degrade power draw increases.

Returning to FIG. 1B, as explained above, the sieve bed 100 is designed such that the length of the sieve path is longer than the longest dimension of the of the sieve bed 100 is expected to improve the useful life of the sieve bed to a point that it is on the same order or even longer than the expected life of the concentrator device. This expected to solve some industry problems that until now have only been handled by making the sieve beds (beds) more easily replaceable.

In the embodiment shown in FIG. 1B, housing 120 is of a cylindrical shape (e.g., circular, elliptic, parabolic, hyperbolic, oblique, or other types of cylinders). Other shapes may be considered that are consistent with the present disclosure and facilitate operation as described herein. For example, housing 120 may have a rectangular-cylindrical shape, a square-cylindrical shape, a prism, or other shapes that define a volume (that can hold a sieve material within the volume). In some embodiments, housing 120 and the inner tube have the same shape. In some embodiments, the inner tube and housing 120 may be of different shapes. In some embodiments, flow path 150 may be reversed such that the first passage through which air is guided is through the inner tube 170 and the second passage from which oxygen enriched gas is guided is through the annular space between the I.D. of the housing 120 and the O.D. of the inner tube 170.

In some embodiments, the multi-pass path comprises multiple passages (e.g., more than two passages). In these embodiments, housing 120 may be compartmentalized (and/or partitioned) such that the gas is guided through the multiple passages, defined by the multiple compartments, before exiting the sieve bed 100 (e.g., housing 120 may include multiple plates, inserts, surfaces, beds, chambers, or receptacles that are placed in the housing and that are in series with one another).

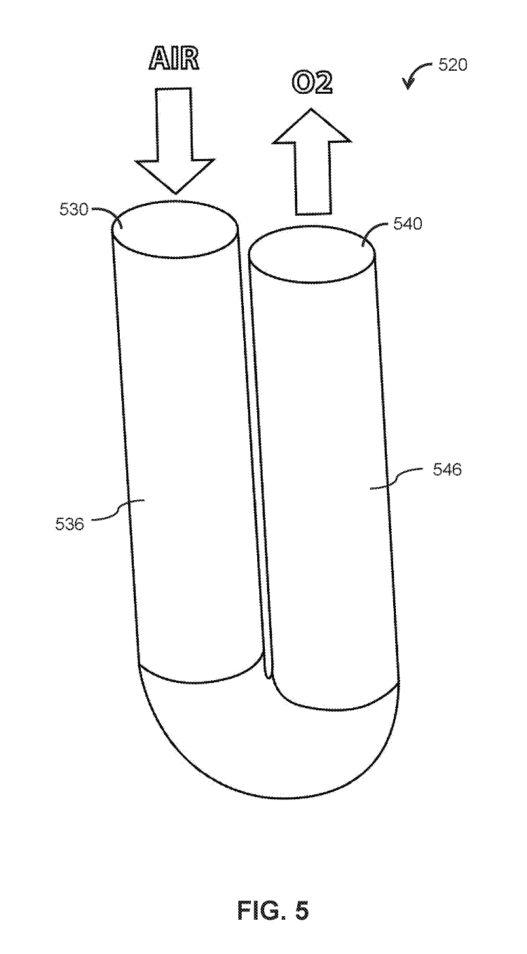

FIG. 5 illustrates an example of a housing 520 that may be used in the present sieve bed (e.g., instead of housing 120 shown in FIG. 1) in accordance with one or more embodiments. Housing 520 of FIG. 5 has a U shape. In operation, air (or other oxygen comprising gas) is guided through sieve material (inside the U shape housing) from inlet 530 and oxygen rich gas exits housing 520 from outlet 540. The flow path of oxygen comprising gas, in some embodiments, extends from inlet 530, down a longitudinal axis turns about 180 degrees to the opposite direction to the outlet at end 540.

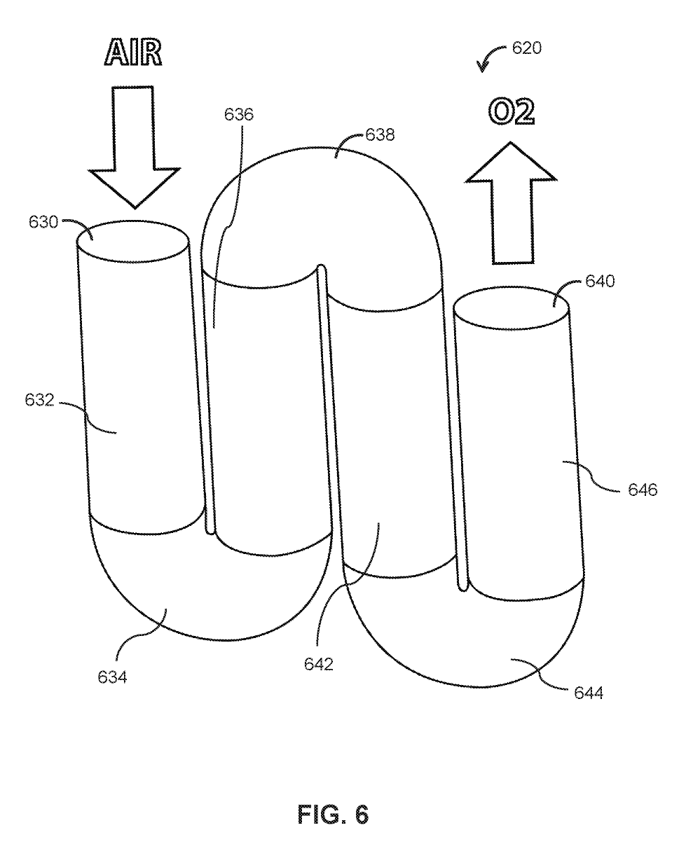

FIG. 6 illustrates another example of a housing 620 in accordance with one or more embodiments. Housing 620 defines multi-path passages for the oxygen comprising gas (e.g., a serpentine and/or serial path). In some embodiments, the flow path extends from inlet 630, through the sieve filled serpentine tubing to the outlet at end 640, where oxygen rich gas exits housing 620. In some embodiments, the path formed by housing 620 may be a multi-path pass having a plurality of such passages (more than four passages) along length L of housing 620.

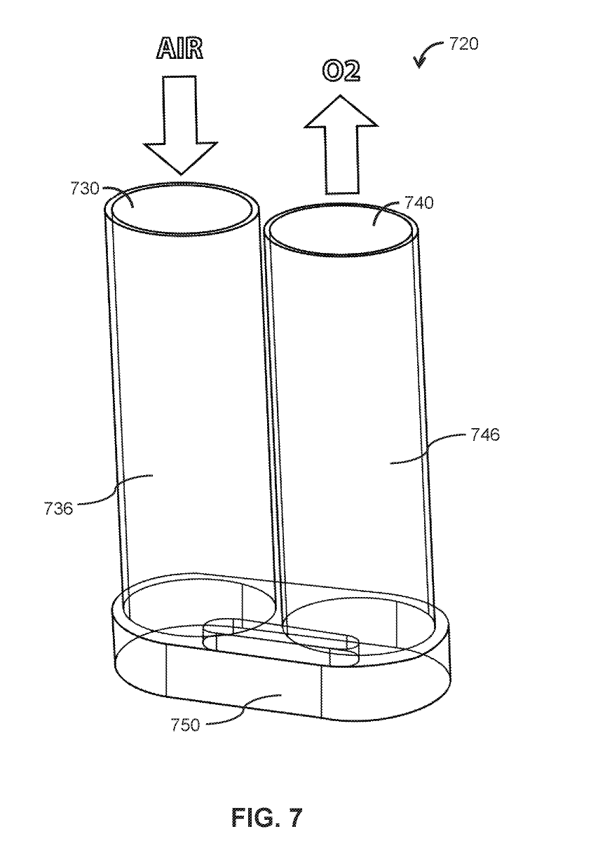

FIG. 7 illustrates yet another example of a housing 720 in accordance with one or more embodiments. In this example, housing 720 is formed by two cylindrical elongated housings in fluid communication through an end cap 750. In operation, air (or other oxygen comprising gas) is guided through sieve material from inlet 730 and oxygen rich gas exits housing 720 from outlet 740.

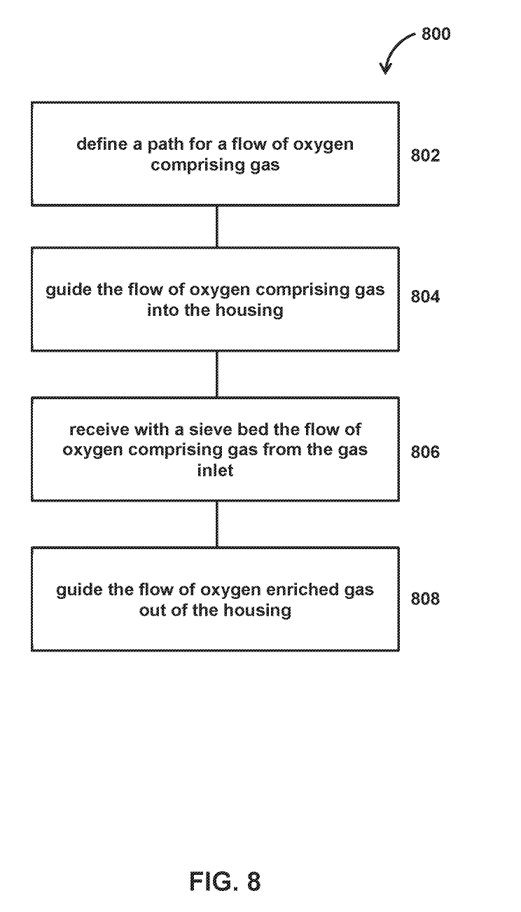

FIG. 8 illustrates a method 800 for concentrating oxygen. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting.

At an operation 802, a path for a flow of oxygen comprising gas is defined a housing. In some embodiments, operation 802 is performed by a housing the same as or similar to housing 120 (shown in FIG. 1 and described herein).

At an operation 804, a flow of oxygen comprising gas is guided into the housing with a gas inlet. In some embodiments, operation 804 is performed by a gas inlet the same as or similar to gas inlet 130 (shown in FIG. 1 and described herein.) In some embodiments, the housing has a length and a diameter, wherein the length is longer than the diameter, and wherein the path of the flow of oxygen comprising gas through the sieve bed is longer than the length of the sieve bed.

At an operation 806, the flow of oxygen comprising gas is received from the gas inlet with a sieve material. In some embodiments, operation 806 is performed by a sieve material. In some embodiments, the flow of oxygen comprising gas flows through the sieve bed and oxygen enriched gas flows out of the sieve bed via a gas outlet, wherein the path of the flow of oxygen comprising gas through the sieve bed is longer than a longest dimension of the sieve bed assembly. In some embodiments, the housing defines the path of the flow of oxygen comprising gas through the sieve bed as a serpentine-shaped path for the flow of oxygen comprising gas through the sieve bed.

At an operation 808, the flow of oxygen enriched gas is guided out of the housing with a gas outlet. In some embodiments, the gas inlet and the gas outlet are located on a same end of the housing. In some embodiments, operation 808 is performed by a gas outlet the same as or similar to gas outlet 140 (shown in FIG. 1-B and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A sieve bed, the sieve bed comprising:
a housing configured to define a path for a flow of oxygen comprising gas a gas inlet configured to guide the flow of oxygen comprising gas into the sieve bed;
a gas outlet configured to guide a flow of oxygen enriched gas out of the sieve bed; and
a sieve material configured to receive the flow of oxygen comprising gas from the gas inlet, wherein the flow of oxygen comprising gas flows through the sieve material and oxygen enriched gas flows out of the sieve material via the gas outlet, and wherein the path of the flow of oxygen comprising gas through the sieve material is longer than a longest dimension of the sieve bed.

2. The device of claim 1, wherein the gas inlet and the gas outlet are located on a same end of the sieve bed.

3. The device of claim 1, wherein the sieve bed includes a counter flow passageway within the sieve bed with concentric flow paths one inside the other to define a multi-pass path for the flow of oxygen comprising gas down one path change direction at the closed end of the sieve bed then flow back up the second path to a gas outlet residing at the same end of the sieve bed as is the gas inlet.

4. The device of claim 3, wherein the inner and outer flow paths are not concentric.

5. The device of claim 1, wherein the housing defines the path of the flow of oxygen comprising gas through the sieve material as a serpentine-shaped path for the flow of oxygen comprising gas through the sieve bed.

6. The device of claim 1, wherein the sieve bed has a length and a diameter, wherein the length is longer than the diameter, and wherein the path of the flow of oxygen comprising gas through the sieve bed is longer than the length of the housing.

7. A method for concentrating oxygen, the method comprising:
defining a path for a flow of oxygen comprising gas;
guiding with a gas inlet the flow of oxygen comprising gas into the housing;
receiving with a sieve material the flow of oxygen comprising gas from the gas inlet, wherein the flow of oxygen comprising gas flows through the sieve material and oxygen enriched gas flows out of the sieve material via a gas outlet, and wherein the path of the flow of oxygen comprising gas through the sieve material is longer than a longest dimension of the sieve bed; and
guiding with the gas outlet the flow of oxygen enriched gas out of the sieve bed.

8. The method of claim 7, wherein the gas inlet and the gas outlet are located on a same end of the sieve bed.

9. The method of claim 7, wherein the sieve bed includes a counter flow passageway within the sieve bed with concentric flow paths one inside the other to define a multi-pass path for the flow of oxygen comprising gas down one path change direction at the closed end of the sieve bed then flow back up the second path to a gas outlet residing at the same end of the sieve bed as is the gas inlet.

10. The method of claim 9, wherein the inner and outer flow paths are not concentric.

11. The method of claim 7, wherein the housing defines the path of the flow of oxygen comprising gas through the sieve bed as a serpentine-shaped path for the flow of oxygen comprising gas through the sieve bed.

12. The method of claim 7, wherein the sieve bed has a length and a diameter, wherein the length is longer than the diameter, and wherein the path of the flow of oxygen comprising gas through the sieve bed is longer than the length.

13. An adsorption device, the device comprising:
means for defining a path for a flow of oxygen comprising gas, the means for defining the path comprising:
means for guiding the flow of oxygen comprising gas into the means for defining the path;
means for guiding a flow of oxygen enriched gas out of the means for defining the path; and
means for receiving the flow of oxygen comprising gas from the means for guiding the flow of oxygen comprising gas, wherein the flow of oxygen comprising gas flows through the means for receiving the flow of oxygen comprising gas and oxygen enriched gas flows out of the means for receiving the flow of oxygen comprising gas via means for guiding a flow of oxygen enriched gas out of the means for defining the path, and wherein the path of the flow of oxygen comprising gas is longer than a longest dimension of the means for defining the path.

14. The device of claim 13, wherein the means for guiding the flow of oxygen comprising gas and the means for guiding a flow of oxygen enriched gas are located on a same end of the means for defining the path.

15. The device of claim 13, wherein the means for defining the path includes a counter flow passageway within the sieve bed with concentric flow paths one inside the other to define a multi-pass path for the flow of oxygen comprising gas down one path change direction at the closed end of the sieve bed then flow back up the second path to a gas outlet residing at the same end of the sieve bed as is the gas inlet.

16. A gas separation device, the gas separation device comprising:
two or more adsorption beds configured to preferentially adsorb one or more unwanted gasses from the gas mixture to enrich the flow of gas with the given gas;
a gas inlet configured to receive a flow of a gas mixture containing a given gas to be concentrated; and
a gas outlet configured to guide a flow of the enriched gas out of the adsorption beds, wherein a gas flow path in the two or more adsorption beds is longer than the longest dimension of the gas separation device.

17. The gas separation device of claim 16, wherein the gas inlet and the gas outlet are located on a same end of the two or more adsorption beds.

18. The gas separation device of claim 16, wherein the gas inlet and the gas outlet are located on opposite ends of the two or more adsorption beds.

19. An oxygen concentrator, the oxygen concentrator comprising:
two or more sieve beds configured to preferentially adsorb nitrogen from the flow of ambient air and enrich the flow of gas with the oxygen;
a gas inlet configured to receive a flow of ambient air; and
a gas outlet configured to guide a flow of the oxygen enriched gas out of the sieve beds, wherein a gas flow path in a given sieve bed is longer than a longest dimension of the given sieve bed.

20. The oxygen concentrator of claim 19, wherein the gas flow path in the given adsorption bed is longer than a longest dimension of the oxygen concentrator.
